(19) United States
(12) Patent Application Publication
(10) Pub. No.: US 2026/0248110 A1
(43) Pub. Date: Aug. 27, 2026

(54) Dial A Beak

(71) Applicant: Roger Soldano, Charlevoix, MI (US)

(72) Inventor: Roger Soldano, Charlevoix, MI (US)

(21) Appl. No.: 19/315,580

(22) Filed: Aug. 31, 2025

Related U.S. Application Data
(63) Continuation-in-part of application No. 19/062,763, filed on Feb. 25, 2025, now Pat. No. 12,471,574.

(51) Int. Cl. A01K 39/01

(52) U.S. Cl. CPC A01K 39/0113

(57) ABSTRACT

An adjustable bird feeder designed to regulate access to food based on beak length and feeding behavior of different bird species. The feeder includes at least one food cage positioned within a frame and at least one movable face located adjacent to the food cage. A user-operated adjustment mechanism, such as a threaded rod and control knob, moves the face toward or away from the food cage. In a spring-assisted configuration, compression springs provide controlled retraction, while in a single-cage configuration, the face is adjusted without springs using guide rails for stability. The food cage may be aligned or offset with the front grill to adjust aperture size. Crumb collection trays and aluminum fittings enhance durability and prevent food waste. The feeder accommodates suet, seeds, and nuts by modifying cage design and deters squirrels through controlled spacing. In some embodiments, the spacing may alternatively be fixed at a predetermined distance.

### CROSS-REFERENCE TO RELATED APPLICATIONS

This application is a Continuation-in-part of U.S. patent application Ser. No. 19/062,763, filed Feb. 25, 2025, the disclosure of which is incorporated by reference herein in its entirety.

### PRIOR ART

U.S. Pat. No. 5,704,312A describes a feeder designed to accommodate woodpeckers' long tongues and bills while deterring pest birds. It utilizes specific slot dimensions but lacks a movable face mechanism. The Dial-A-Beak invention introduces a user-controlled adjustable face that moves via a threaded rod and knob assembly. Unlike U.S. Pat. No. 5,704,312A's static slot dimensions, Dial-A-Beak allows dynamic adjustments, enabling users to fine-tune access based on beak length and mandible function. Additionally, the spring-assisted mechanism or threaded rod and knob only ensures smooth adjustments, a feature absent in the cited patent.

U.S. Pat. No. 4,188,913A focuses on adjustable dispensing means for seeds of various sizes but does not address suet feeders or mechanisms for separating birds by beak length. Unlike U.S. Pat. No. 4,188,913A, which targets seed dispensing, Dial-A-Beak is designed explicitly for suet feeding, with an innovative movable face that adjusts access based on anatomical features. The adjustable face mechanism is unique and not disclosed in U.S. Pat. No. 4,188,913A.

U.S. Pat. No. 10,687,517B2 discusses a portable feeding device with a telescoping support member but lacks mechanisms related to suet feeders or selective access based on beak length. Dial-A-Beak differentiates itself through its selective feeding mechanism, allowing access adjustments based on beak length and feeding behavior, which is not addressed in U.S. Pat. No. 10,687,517B2. The spring-assisted movable face or the knob and threaded rod only on the single version further distinguishes the invention.

U.S. Pat. No. 3,927,645A provides a general bird feeder design but does not incorporate mechanisms for adjustable access based on beak length. The Dial-A-Beak feeder introduces a dynamic, user-controlled adjustment system using a threaded rod and/or spring mechanism. The ability to adjust feeding access based on anatomical differences sets it apart from the static design disclosed in U.S. Pat. No. 3,927,645A.

U.S. Pat. No. 6,321,686B2 features adjustable feeding openings but lacks a movable face that adjusts the feeding gap based on beak length. While U.S. Pat. No. 6,321,686B2 discusses adjustable openings, Dial-A-Beak provides a movable face controlled by a spring-assisted threaded rod or knob and threaded rod, allowing continuous adjustment of the feeding distance. This dynamic feature, tailored for specific beak lengths and mandible use, is not present in U.S. Pat. No. 6,321,686B2.

U.S. Pat. No. 6,253,707B 1 describes an adjustably selective bird feeder featuring a movable shroud designed to protect and isolate access openings, allowing selective feeding. Unlike this design, the Dial-A-Beak feeder uses a movable face to selectively control access based specifically on beak length, providing a continuously adjustable feeding distance rather than relying on static shroud openings.

U.S. Pat. No. 6,401,658BI discloses a height-adjustable bird feeder that enables raising or lowering relative to a stationary pole. This design focuses on adjusting the feeder's height, not on controlling feeding access based on anatomical features such as beak length. Dial-A-Beak differs by offering user-controlled facial adjustments adjacent to the food cage, allowing dynamic access control tailored to specific species.

U.S. Pat. No. 7,743,732BI covers a bird feeder equipped with an adjustable sealing feeding port that can be moved to secure or expose bird food. Dial-A-Beak differs by enabling continuous adjustment of access distance between a movable face and the food cage, rather than simply sealing or opening feeding ports. The distance-based control in Dial-A-Beak allows for selective feeding based on species-specific anatomical traits, a feature not addressed in U.S. Pat. No. 7,743,732BI.

U.S. Pat. No. 9,839,203B 1 relates to a platform bird feeder that includes an adjustable baffle. The baffle's adjustability focuses on disrupting feeding by undesirable species but does not provide distance control between a movable face and the food cage. Dial-A-Beak's species-selective feeding mechanism based on beak length and mandible use is distinct, offering anatomical selectivity not present in the adjustable baffle design.

U.S. Pat. No. 5,195,460A describes a tube-shaped bird feeder with a tiltable perch, enabling control over the maximum weight of a feeding bird. This weight-based selectivity differs fundamentally from Dial-A-Beak's anatomical access control mechanism, which allows adjustments based solely on beak length and mandible function, independent of the bird's weight.

U.S. Pat. No. 2,504,282A discusses a general feeding apparatus without species-specific access control mechanisms. Unlike U.S. Pat. No. 2,504,282A, Dial-A-Beak introduces a species-selective feeding system based on beak length, facilitated by an adjustable face mechanism. The user-controlled adjustability is a novel feature that distinguishes the invention.

U.S. Pat. No. 5,165,363A describes a selective feeder but does not utilize a movable face adjusted by a threaded rod and spring mechanism or knob and threaded rod. Dial-A-Beak employs a movable face system for species-selective feeding, a mechanism not disclosed in U.S. Pat. No. 5,165,363A. The spring-assisted, user-controlled adjustments provide unique functionality.

U.S. Pat. No. 5,894,813A discusses adjustable feeding ports but lacks a mechanism for selective feeding based on beak length. Unlike U.S. Pat. No. 5,894,813A, which focuses on port adjustment, Dial-A-Beak regulates access via a movable face mechanism, dynamically adjusting feeding access based on anatomical features.

U.S. Pat. No. 3,399,650A provides a general bird feeder design but lacks any adjustable mechanism based on beak length. The Dial-A-Beak invention introduces a movable face controlled by a threaded rod and spring system or knob and threaded rod, providing adjustable access tailored to specific beak lengths and feeding behaviors, distinguishing it from the static design in U.S. Pat. No. 3,399,650A.

### BACKGROUND OF THE INVENTION

The present invention relates generally to bird feeders and, more specifically, to adjustable bird feeders designed to regulate access to bird food based on the anatomical characteristics and feeding behaviors of various bird species. The invention provides a mechanism that allows users to adjust the feeding access distance based on different birds' beak lengths and mandible functions. This enables selective feeding of desired species, such as woodpeckers, while deterring nuisance birds.

Traditional bird feeders, including those designed for suet cakes, typically lack selectivity in terms of which species can access the feed. Feeders with open access often attract aggressive or undesirable bird species, such as starlings, grackles, and blue jays. These birds tend to dominate the feeder, preventing smaller or more desirable species from feeding. As a result, feed is consumed rapidly by nuisance species, leading to increased costs for the user and decreased opportunities for desired bird species to feed.

Various attempts have been made in the prior art to address selective feeding. For example, some feeders use fixed slot dimensions or cages with small rectangular holes that physically limit access based on overall bird size. However, these designs often lack the flexibility needed to accommodate variations in beak length among desirable species.

Additionally, fixed-opening designs may make it difficult for certain birds to access all portions of the feed, leading to feed wastage when uneaten food becomes moldy or rancid.

Another approach in the prior art involves the use of weight-sensitive perches or adjustable seed ports. While these designs can deter certain heavier or larger birds, they are typically not effective for suet feeders or for selectively controlling access based on anatomical features such as beak length. Moreover, weight-sensitive mechanisms may be prone to mechanical failure and require regular maintenance, limiting their long-term reliability.

Some woodpecker feeders attempt to address species selectivity by utilizing small holes in a casing or limiting access based on the tongue length of woodpeckers. However, such feeders often fail because they provide limited access to the feed, resulting in user dissatisfaction and feed spoilage. Birds may not readily adapt to feeders that are difficult to use, further reducing the effectiveness of these designs.

Despite these attempts, there remains a need for an adjustable bird feeder that allows users to control feeding access dynamically, based on the anatomical features of different bird species. A feeder that can adjust the distance between a movable face and a food cage would enable selective feeding of desired species while deterring nuisance species. Additionally, such a design would reduce feed wastage by ensuring that all feed remains accessible to the intended birds.

The present invention addresses these long-standing problems by introducing a user-controlled, adjustable face mechanism that selectively regulates feeding access based on beak length and mandible function. The invention also incorporates adjustable slot apertures on the food cage to provide an additional layer of selectivity. The spring-assisted movement of the adjustable face ensures smooth operation and precise control, distinguishing the invention from existing feeders that rely on fixed openings or weight-sensitive mechanisms.

In summary, the present invention fills a critical gap in the field of bird feeders by providing a flexible, user-adjustable solution that accommodates variations in bird anatomy and behavior. The Dial-A-Beak adjustable bird feeder represents a significant improvement over prior art by offering dynamic feeding control, reducing feed wastage, and increasing user satisfaction through reliable, maintenance-free operation.

### SUMMARY OF THE INVENTION

The present invention, referred to as the “Dial-A-Beak” adjustable bird feeder, provides a novel solution for selective feeding of bird species based on anatomical characteristics such as beak length and mandible function. The invention offers a user-controlled mechanism that allows precise adjustment of the distance between a movable face and a food cage. By turning a control knob connected to a threaded rod, users can advance or retract the face, thereby regulating access to the food. The clockwise rotation of the knob compresses springs located at the corners of the face, decreasing the distance between the face and the food cage and allowing birds with shorter beaks to access the food. Conversely, counterclockwise rotation releases the springs, increasing the distance and restricting access to shorter-beaked birds, thereby favoring species such as woodpeckers.

In an alternative single-sided embodiment, the feeder operates on the same principle of adjusting the distance between the face and the food but uses a simpler mechanism that does not require springs. In this configuration, the face is guided along support structures, and the rotational momentum of the threaded rod and knob assembly enables movement. This design provides a more streamlined construction while maintaining the selective feeding functionality of the primary embodiment.

The invention also includes adjustable slot apertures on the food cage, which provide an additional layer of selectivity by controlling access based on how different bird species use their mandibles to grasp food. While suet is the primary food source intended for use with the Dial-A-Beak feeder, the design can be adapted for other types of bird food, such as seeds, nuts, and fruits, by modifying the cage to accommodate various food forms.

Another significant feature of the invention is its ability to deter nuisance animals such as squirrels. Even at relatively small distances between the movable face and the food cage, squirrels cannot reach the food, providing an effective deterrent without additional barriers or complex mechanisms.

The Dial-A-Beak feeder can be configured with a single or double-sided design, allowing for flexibility in various environments. In the double-sided configuration, two stacked suet cages can be independently adjusted using separate knobs and threaded rod assemblies. This enables users to cater to different species on each side by customizing the feeding distance according to the anatomical requirements of the target birds.

The Dial-A-Beak adjustable bird feeder provides a versatile, user-controlled feeding solution that dynamically accommodates the anatomical differences among bird species. Its unique combination of a movable face mechanism, spring-assisted or springless operation, adjustable cage apertures, and adaptability for various food types substantially improve existing feeders. The invention reduces feed wastage, enhances user satisfaction, and provides reliable, maintenance-free operation, representing a significant advancement in the field of bird-feeding technology.

### BRIEF DESCRIPTION OF DRAWING

FIG. 1 is a perspective view of the assembled Dial-A-Beak adjustable bird feeder, illustrating the overall three-dimensional configuration.

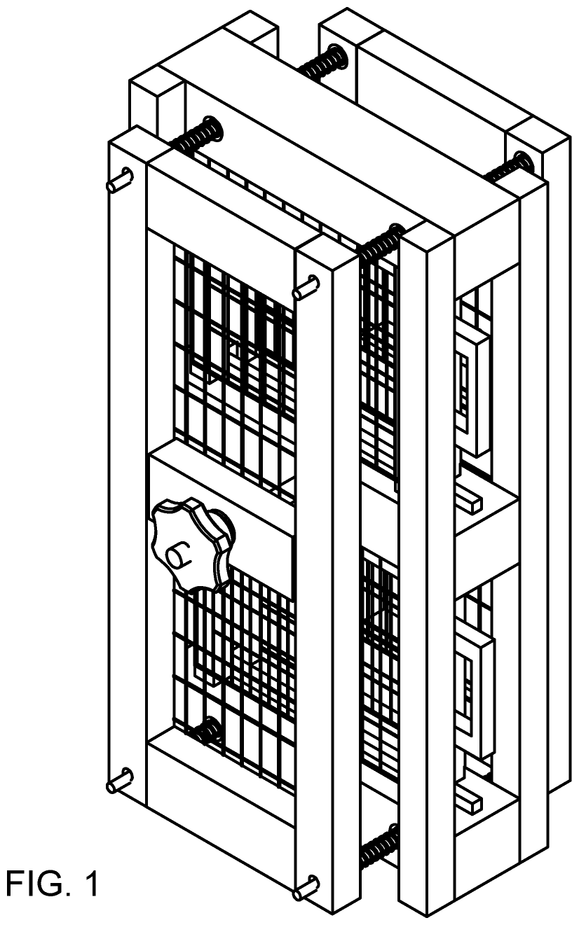

FIG. 2 is an exploded perspective view of the spring-assisted Dial-A-Beak bird feeder, illustrating its major structural and functional components.

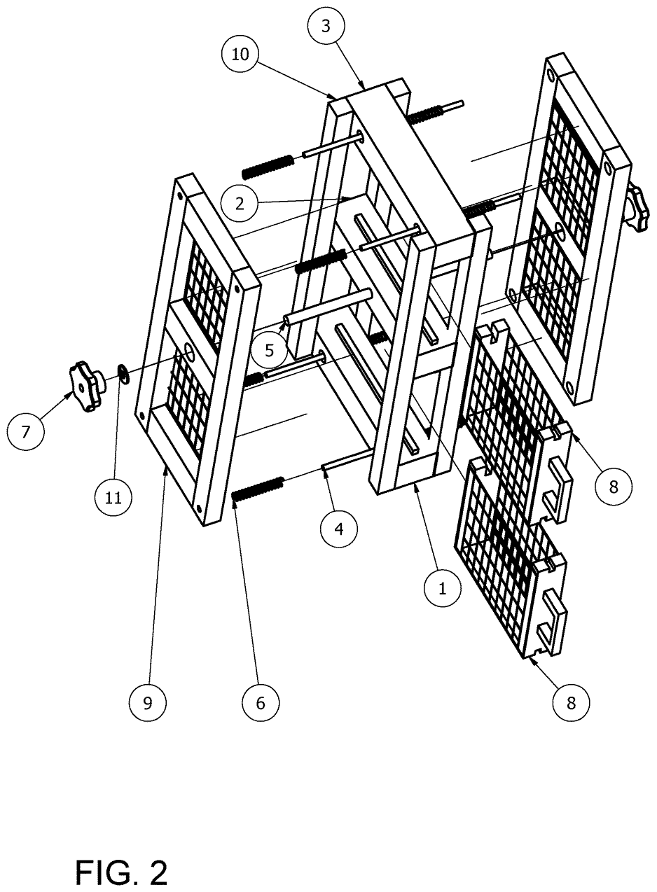

FIG. 2A is a continuation of the exploded perspective view of FIG. 2, illustrating additional components such as angled aluminum fittings and crumb collection trays.

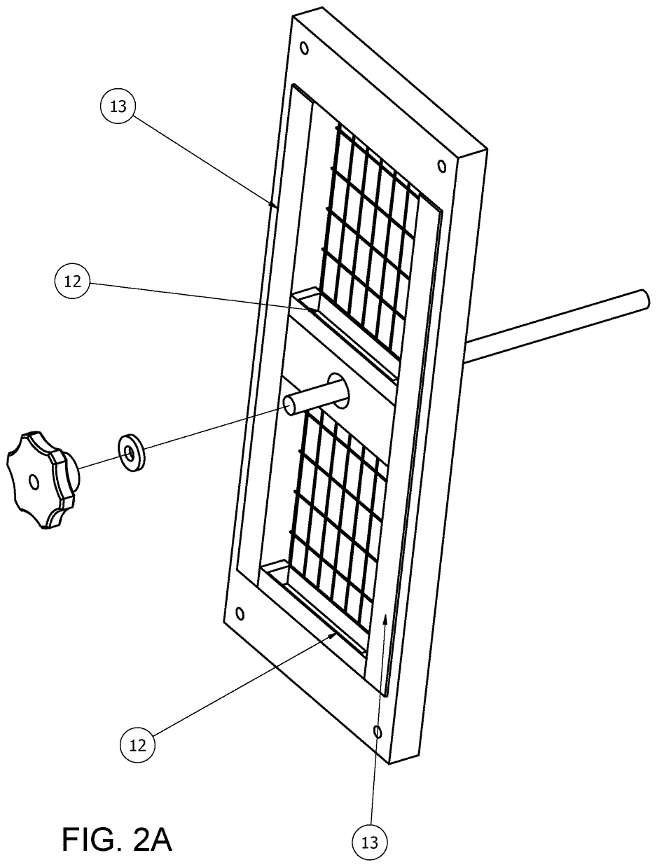

FIG. 2B is a cutaway view of the spring-assisted Dial-A-Beak feeder of FIG. 1, illustrating the interaction of the faces, food cages, threaded rod, compression springs, and spring guides.

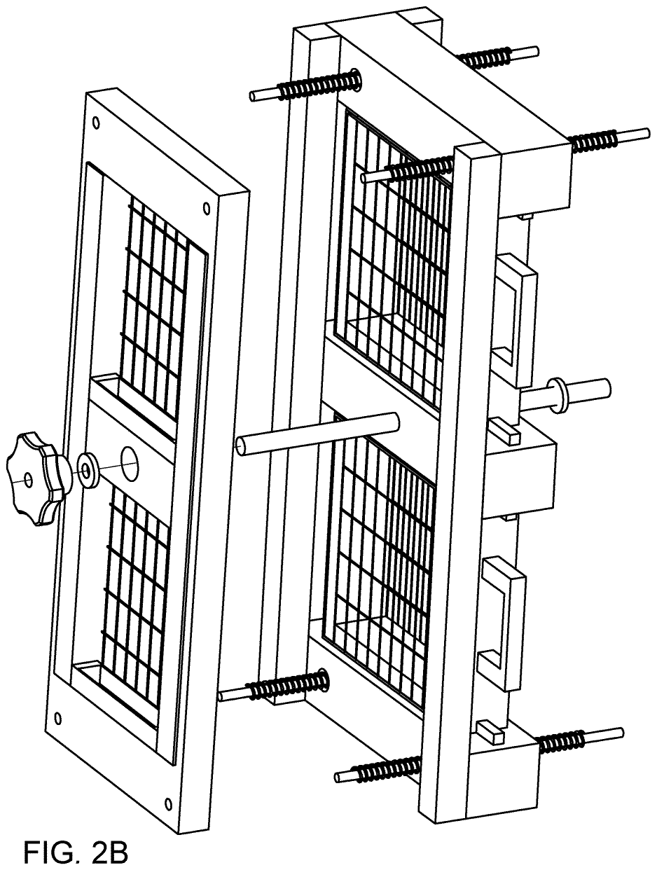

FIG. 2C illustrates the operation of stacked food cages sliding into frame slots and their alignment with the movable faces.

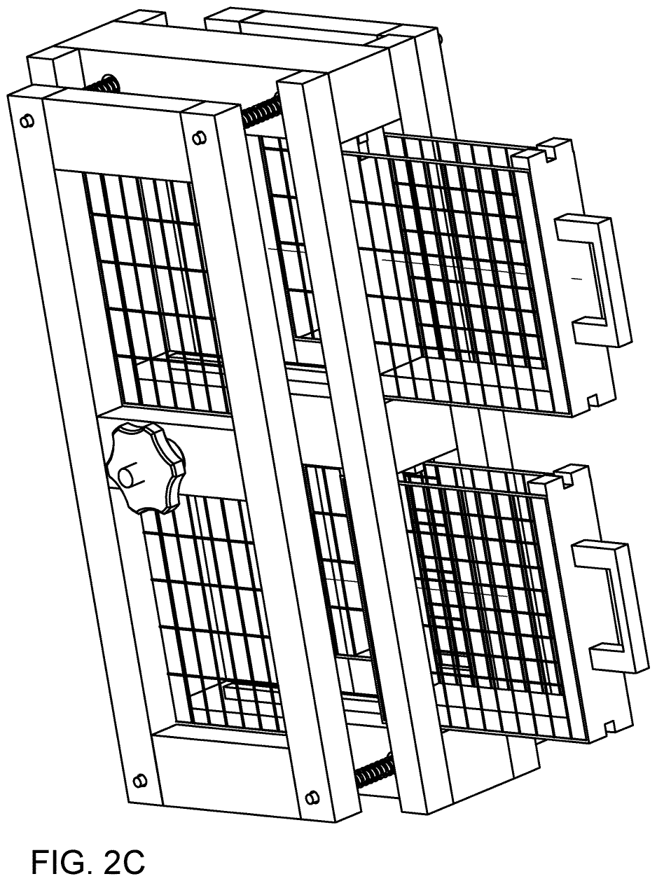

FIG. 3 is a right-side view of the adjustable bird feeder.

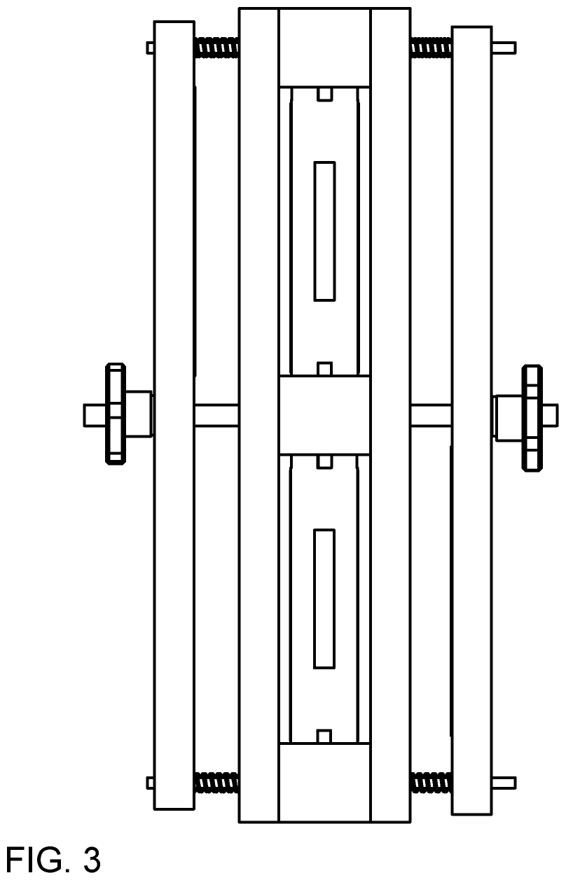

FIG. 4 is a left-side view of the adjustable bird feeder.

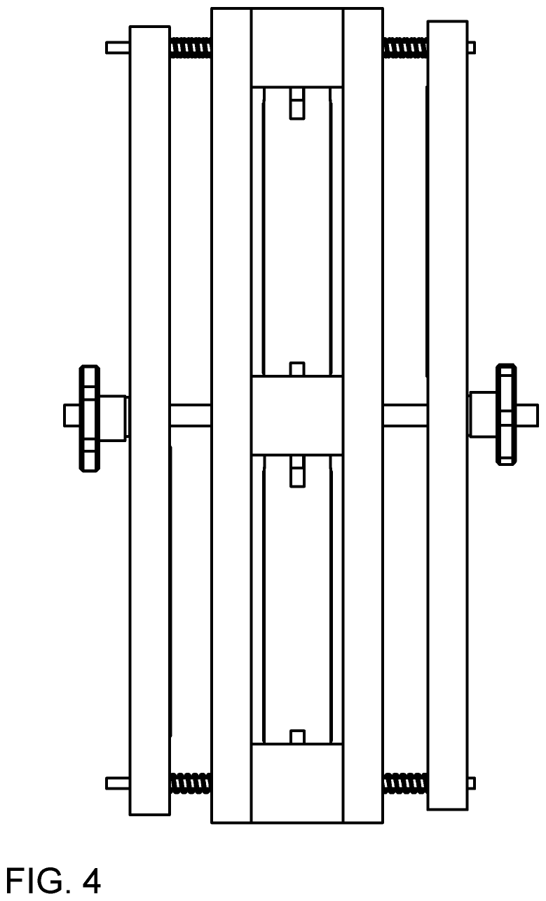

FIG. 5 is a top view of the adjustable bird feeder.

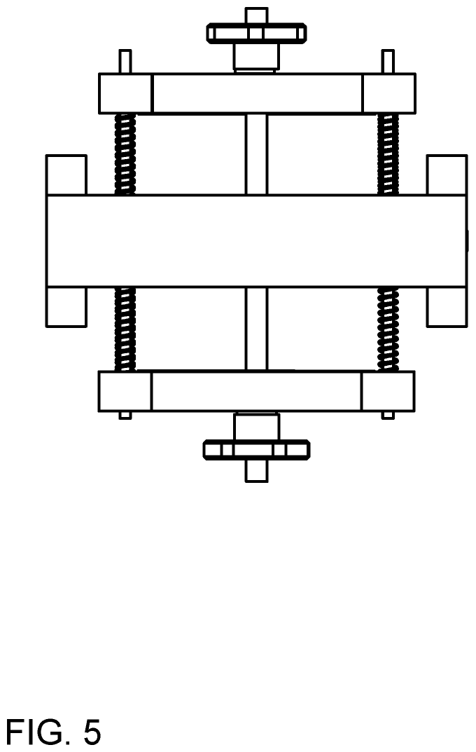

FIG. 6 is a bottom view of the adjustable bird feeder.

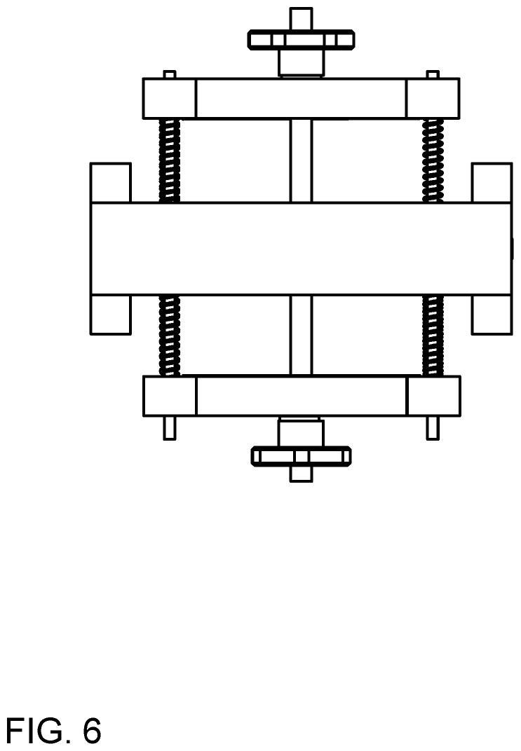

FIG. 7 is a perspective view of a single-cage embodiment of the adjustable Dial-A-Beak bird feeder.

FIG. 8 is an exploded perspective view of the single-cage embodiment of the Dial-A-Beak bird feeder.

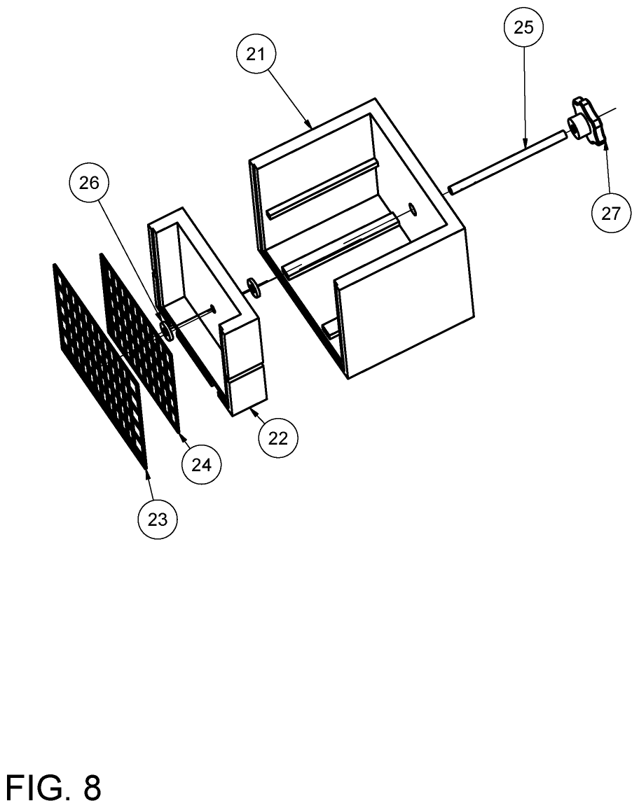

FIG. 9 is a perspective view of a fixed-distance bird feeder embodiment.

### DETAILED DESCRIPTION OF THE DRAWING

The Dial-A-Beak adjustable bird feeder is designed to regulate access to bird food based on the anatomical characteristics of different bird species, specifically beak length. The feeder incorporates a movable face mechanism that the user can adjust to increase or decrease the distance between the face and the food cage. This adjustment allows selective feeding by desired bird species while deterring access by nuisance birds and animals such as squirrels.

The feeder frame includes a lower frame support (1), middle frame support (2), and top frame support (3), providing overall structural integrity. Spring guides (4) are located at each corner of the frame and extend through the front and rear faces. A threaded rod (5) runs through both faces and enables the movement of the faces (9) via rotation. Compression springs (6) are positioned over the spring guides (4) and provide a spring-assisted mechanism for face adjustment. Control knobs (7) are attached to each end of the threaded rod (5), allowing users to rotate the rod clockwise or counterclockwise to move the faces (9). Washers (11) are placed between the threaded rod (5) and the faces (9), ensuring smooth operation during adjustments.

Food cages (8) fit securely into frame slots in a stacked configuration. The alignment of the food cages (8) with the movable faces (9) can be adjusted to control aperture size, regulating access to the food based on the beak length of feeding birds. Crumb collection trays (12) located at the bottom of each feeding compartment collect fallen food fragments, which remain accessible to birds while protecting the middle and bottom sections of the feeder frame.

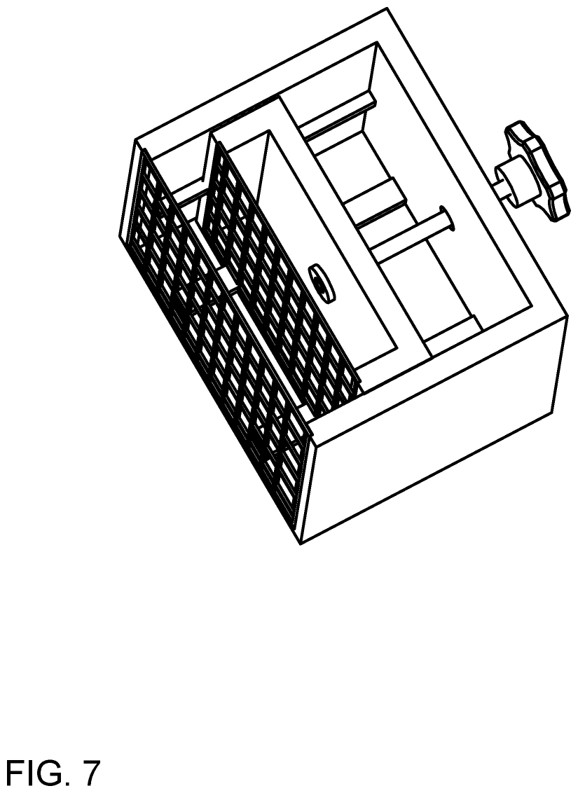

Angled aluminum fittings (13) are located on each side of the front and rear faces, providing structural support and protection from damage caused by bird beaks. The single-cage version of the feeder, shown in FIG. 7, operates without compression springs. In this configuration, a threaded rod (25) and control knob (27) provide the necessary adjustments. The housing (21) includes integrated rails that stabilize the food cage (22) during movement. The food cage grille (24) regulates access in coordination with the front grille (23) of the housing.

Washers (26) protect the food cage (22) by absorbing force during adjustments.

The single-cage version operates on the same principle as the spring-assisted model, allowing selective feeding based on beak length, but employs a simplified mechanical design without compression springs.

The adjustment mechanism may include various user-controlled devices such as hand-operated knobs, levers, cranks, threaded rods with control knobs, rotary handles, or similar mechanical devices that allow a user to manually adjust the position of the movable face through direct physical manipulation. Alternative adjustment mechanisms include an electronically operated mechanism, a motor-driven mechanism, a pneumatic actuator, a hydraulic actuator, a hydraulic adjuster, cam-based systems, magnetically assisted sliders, gears. These mechanisms provide tactile feedback and precise control over the adjustment process, enabling users to fine-tune the feeding access distance based on the specific beak lengths of target bird species.

The integrated rails may alternatively include telescoping tracks, sliding grooves, roller-based guides, magnetically assisted sliders, gear-driven assemblies, tension-based cable systems, electronic actuators, pneumatic or hydraulic actuators, or any equivalent mechanical, electrical, or magnetic system designed to ensure precise aperture adjustments, maintains proper alignment of the food cage within the housing during feeding operations, and prevents lateral or vertical displacement of the food cage.

The food cage includes materials selected from the group consisting of metals, including aluminum and stainless steel; plastics, including UV-resistant polymers; composite materials; or any other material suitable for outdoor use and maintaining structural integrity. Aluminum offers lightweight construction with excellent weather resistance, while stainless steel provides superior strength and corrosion resistance. The crumb collection tray (12) comprises a formed aluminum tray positioned at the bottom portion of each food cage. The tray protects the middle and bottom portions of the feeder frame from food debris and moisture while providing an accessible feeding area for birds to consume fallen food fragments.”

The following disclosure describes additional embodiments not present in the originally filed specification and forms part of this Continuation-in-Part application.

### Alternative Fixed-Distance Embodiment

In alternative embodiments, the distance between the food cage and the front face is fixed rather than adjustable. In such embodiments, the at least one food cage is secured at a predetermined distance from the front face of the housing. The predetermined distance is selected based on the characteristic beak lengths of target and non-target bird species. For example, the distance may be set so that woodpeckers and other desired species are able to access the bird food, while nuisance birds such as starlings, grackles, and blue jays are prevented from reaching the food. This configuration maintains the principle of selective feeding control without requiring any user adjustment.

### Structural Implementation of Fixed Spacing

The fixed spacing may be implemented in various ways, including but not limited to: (i) rigid spacer elements positioned between the front face and the at least one food cage; (ii) integrally molding the front face and the food cage as a unitary structure during manufacture; (iii) one or more brackets, rods, rails, or panels that secure the food cage in position relative to the front face; or (iv) locking assemblies, screws, slots, pins, or fasteners that hold the food cage at the predetermined distance. In other embodiments, an adjustment mechanism may initially allow variation in spacing but is then locked or fixed at a predetermined distance for continued use. The food cage may be composed of wood, metals such as aluminum or stainless steel, polymers including UV-resistant plastics, composite materials, or other durable outdoor-grade materials. The front face may be formed from the same or different materials and may optionally include protective coatings to withstand repeated beak strikes. All such implementations and their functional equivalents are considered within the scope of the invention, provided they maintain the spacing dimension without unintended movement.

### Dimensional Ranges and Functional Results

The predetermined spacing (33) is selected to achieve species-selective access based on beak length and feeding behavior. In some embodiments, (33) is between about 5 millimeters and about 50 millimeters (about 0.20-1.97 inches), inclusive. Within this range, representative sub-ranges (also inclusive) may be used to suit particular conditions, for example 8-15 mm, 12-25 mm, or 18-35 mm. The specific value of D may be chosen in view of the food form (e.g., suet density or thickness, seed or nut size), anticipated nuisance species, desired target species, and environmental or manufacturing considerations. The spacing is dimensioned so that nuisance birds (e.g., starlings, grackles, and blue jays) are unable to insert their beaks sufficiently to contact the food, while desired species such as woodpeckers can feed efficiently. Unless otherwise stated, the stated dimensions and ranges are inclusive, contemplate equivalents and sub-ranges, and permit typical manufacturing tolerances (e.g., ±0.5 mm or about ±10%) without departing from the fixed-distance functionality.

### Single and Stacked Cage Variants

In some embodiments, the bird feeder includes a single food cage maintained at a fixed distance from the front face. In other embodiments, two or more food cages are arranged vertically in a stacked configuration. Each food cage in the stacked arrangement is maintained at the same predetermined distance from the front face by corresponding spacer structures, integrally molded supports, or equivalent means. The stacked configuration permits increased food capacity while preserving the fixed-distance exclusion effect for nuisance species.

### Loading and Maintenance

The fixed-distance bird feeder may be configured for top-loading, side-loading, or bottom-loading of the food cage. In one example, the food cage is top-loaded into the housing and fixed in place by engagement with brackets or slots that secure the cage at the predetermined distance. In another example, the cage and front face may be formed as a single molded assembly that is inserted into the housing as a unit. These configurations ensure ease of reloading while maintaining structural alignment and the integrity of the fixed spacing.

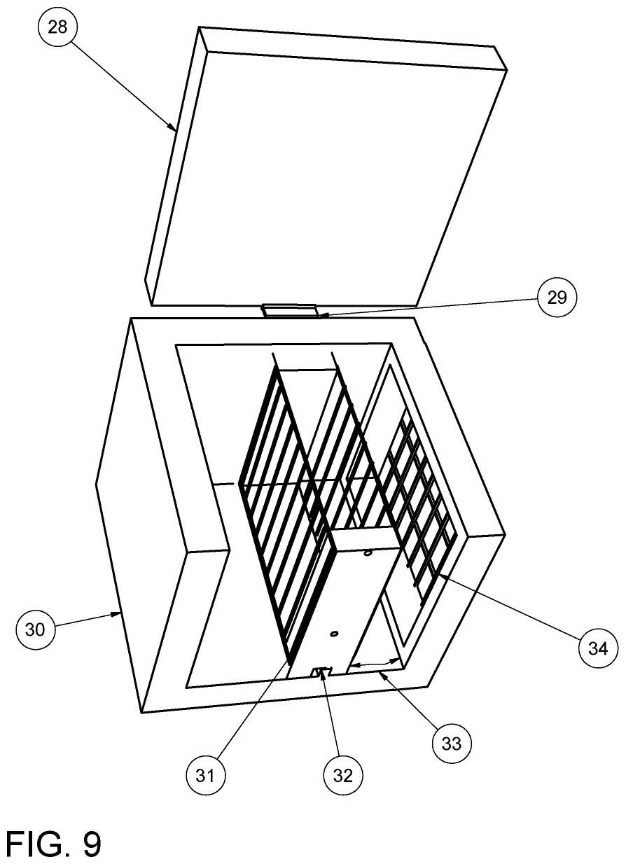

As shown in FIG. 9, the housing (30) includes side walls, a top, and a base (one side wall omitted for clarity). A front face and grille (34) are disposed adjacent to at least one food cage (31) positioned within the housing. The housing may further include a lid (28) pivotally attached by a hinge (29) to permit access to the food cage. The food cage (31) is maintained at a predetermined, fixed distance from the front face (34), this spacing being indicated in the figure at reference numeral (33) and hereinafter also referred to as distance D. One or more support structures (32) may be provided to maintain distance (33), including but not limited to tongue-and-groove joints, rigid spacer elements, brackets, screws, slots, molded connections, rails, rods, locking assemblies, wedges, or functional equivalents thereof, each configured to prevent unintended movement of the food cage relative to the front face. The predetermined fixed distance (33, D) is dimensioned such that birds having shorter beaks than the threshold distance cannot reach the food, while birds having longer beaks than the threshold distance, such as woodpeckers, are able to access the food. In contrast, nuisance species including starlings, grackles, and blue jays are excluded because their shorter beaks cannot bridge the spacing (33, D). Although FIG. 9 depicts a single food cage, the fixed-distance concept applies equally to multiple cages arranged in stacked or side-by-side configurations, and may also be implemented in embodiments where an adjustment mechanism initially allows variation in spacing but is then locked at the predetermined fixed distance (33, D) for continued use. Please amend the claims as follows:

1. A bird feeder comprising:
a housing;
at least one food cage positioned within the housing and configured to hold bird food;
a front face of the housing disposed adjacent to the at least one food cage; and
at least one spacing member comprising one or more rigid spacers, brackets, molded supports, rails, rods, pins, screws, slotted stops, and locking assemblies, the spacing member fixing a predetermined non-adjustable distance (D) between the front face and the at least one food cage and being configured to maintain said distance without unintended movement,
wherein D is dimensioned to permit access to the bird food by birds having beaks longer than a threshold length through an aperture in the front face and is selected based on beak length and feeding behavior of target and non-target bird species so that desired bird species are able to obtain the bird food across the predetermined non-adjustable distance (D), while nuisance birds are prevented from obtaining the bird food across the predetermined non-adjustable distance (D).

2. The bird feeder of claim 1, wherein the spacing member comprises rigid spacer elements, brackets, or molded supports positioned between the front face and the at least one food cage.

3. The bird feeder of claim 1, wherein the front face and the at least one food cage are integrally formed as a unitary structure that fixes the predetermined distance D.

4. The bird feeder of claim 1, wherein the spacing member comprises one or more screws, pins, fasteners, or a locking assembly configured to secure the at least one food cage at the predetermined distance D.

5. The bird feeder of claim 1, wherein D is between about 5 millimeters and about 50 millimeters, inclusive.

6. The bird feeder of claim 1, wherein at least one of (i) the at least one food cage and (ii) the front face is formed from wood, aluminum, stainless steel, a UV-resistant polymer, a composite material, or an equivalent outdoor-grade material.

7. The bird feeder of claim 1, wherein the at least one food cage is top-loaded, side-loaded, front-loaded, or bottom-loaded into the housing, or is formed with the front face as a single molded assembly insertable as a unit.

8. The bird feeder of claim 1, wherein the at least one food cage comprises two or more food cages arranged vertically in a stacked configuration or in a side-by-side arrangement, each cage being maintained at the predetermined distance D from the front face by corresponding spacing members.

9. (canceled)

10. The bird feeder of claim 1, wherein the front face comprises a grille, and wherein the predetermined distance D is dimensioned to exclude birds with shorter beaks that are physically unable to extend through the grille to contact the bird food while permitting birds with longer beaks that can extend through the grille to contact the bird food and obtain the bird food.

11. The bird feeder of claim ±10, wherein the grille includes apertures, slots, mesh, lattice, or perforated panels dimensioned to selectively allow beak entry based on beak length.
